(19) United States
(12) Patent Application Publication
(10) Pub. No.: US 2005/0185205 A1
(43) Pub. Date: Aug. 25, 2005

(54) Digital printer for transferring and printing images from a digital camera and a computer

(76) Inventors: Neal Eckhaus, Rochester, NY (US); Jason R. Oliver, Rush, NY (US)

Correspondence Address: Mark G. Bocchetti;Patent Legal Staff, Eastman Kodak Company, 343 State Street, Rochester, NY, 14650-2201, US

(21) Appl. No.: 10/783,005

(22) Filed: Feb. 20, 2004

(51) Int. Cl. G06F 3/00; G06F 3/12; G06F 13/00; H04N 5/225

(52) U.S. Cl. 358/1.13; 348/207.11; 348/207.2; 710/8; 710/14

(57) ABSTRACT

The present invention is a digital printer comprising a marking apparatus adapted to print images, a first electrical interface for connecting to a digital camera, a second electrical interface for connecting to a computer, and a processor for detecting when the digital camera is connected to the first electrical interface, for controlling the marking apparatus to print images provided from the digital camera when the digital camera is connected to the first electrical interface, and for controlling the marking apparatus to print images provided from the computer over the second interface when the digital camera is not connected to the first electrical interface.

### CROSS REFERENCE TO RELATED APPLICATIONS

Reference is made to commonly-assigned U.S. patent application Ser. No. 10/375,669 filed Feb. 27, 2003, entitled SYSTEM AND METHOD FOR VIEWING AND SELECTING IMAGES FOR PRINTING to Oliver et al.

### FIELD OF THE INVENTION

The present invention relates to a color digital photography system including a digital camera, a digital printer, and a computer and, more particularly, to a system and method for transferring images captured by the digital camera to the computer and printing images from the digital camera and the computer using the digital printer.

### BACKGROUND OF THE INVENTION

Digital cameras and digital printers are available from the Eastman Kodak Company and many other suppliers. Consumer digital cameras, such as the Kodak DX4330 camera, capture images with a single-chip color CCD image sensor, process the images to provide “finished” RGB images, compress the images using JPEG compression, and store the images using a removable memory card. The images can be reviewed on an LCD image display on the back of the camera, and unwanted images can be deleted. Images can be selected for printing as they are reviewed, by pressing a “print” button as the image is displayed, and then indicating the number of prints desired. The camera then produces a DPOF print order file which identifies the images to be printed.

The memory card can then be removed from the digital camera and placed in a stand-alone digital color printer, such as the Kodak Personal Picture Maker PM200. This printer includes memory card slots for the well-known Compact Flash and Smart Media Flash EPROM memory cards. The DPOF file can be read by the printer, and the desired prints can be produced, for example by using a color ink jet head which marks photo ink jet paper.

The memory card can then be removed from the stand-along printer, and placed into a card reader attached to a separate home computer. The images can then be transferred from the memory card to the hard drive of the home computer.

Unfortunately, this prior art system requires the user to perform a sequence of operations in order to transfer and print the images. This includes removing the memory card from the camera, placing it into the stand-along printer to print the images, and then placing it into the memory card reader of the home computer to transfer the images. What is needed is an easier method of transferring and printing images captured by a digital camera.

### SUMMARY OF THE INVENTION

The present invention provides a digital printer comprising a marking apparatus adapted to print images, a first electrical interface for connecting to a digital camera, a second electrical interface for connecting to a computer, and a processor for detecting when the digital camera is connected to the first electrical interface, for controlling the marking apparatus to print images provided from the digital camera when the digital camera is connected to the first electrical interface, and for controlling the marking apparatus to print images provided from the computer over the second interface when the digital camera is not connected to the first electrical interface.

The present invention further provides for a method of printing images which comprises the steps of: providing a printer comprising a marking apparatus adapted to print images, a first electrical interface for connecting to a digital camera, and a second electrical interface for connecting to a computer; detecting when a digital camera is connected to the first electrical interface; controlling the marking apparatus to print images provided from the digital camera when the digital camera is connected to the first electrical interface; and controlling the marking apparatus to print images provided from the computer over the second interface when the digital camera is not connected to the first electrical interface.

### BRIEF DESCRIPTION OF THE DRAWINGS

FIG. 1 depicts a block diagram of a digital camera that captures and stores images;

FIG. 2 depicts a block diagram of a digital printer having a first electrical interface for connecting to the digital camera of FIG. 1 and a second electrical interface for connecting to a computer;

FIG. 3 depicts a perspective view of the digital camera and the digital printer;

FIG. 4 depicts a top view of the digital printer; and

FIG. 5 depicts a flow diagram of a method for printing and transferring images using the digital printer.

### DETAILED DESCRIPTION OF THE INVENTION

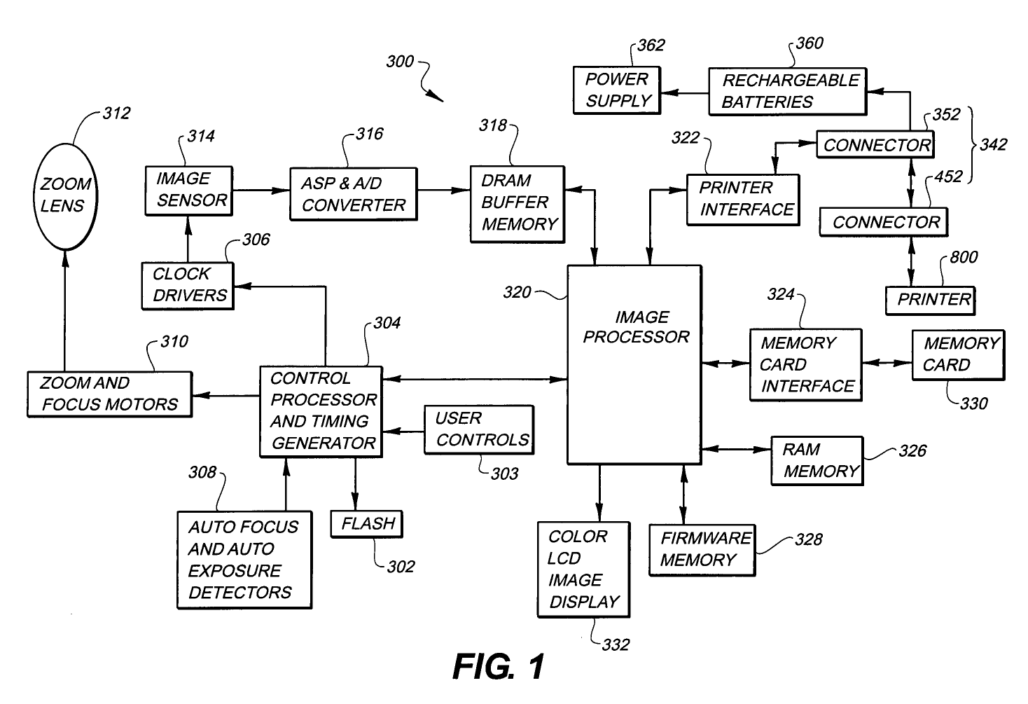

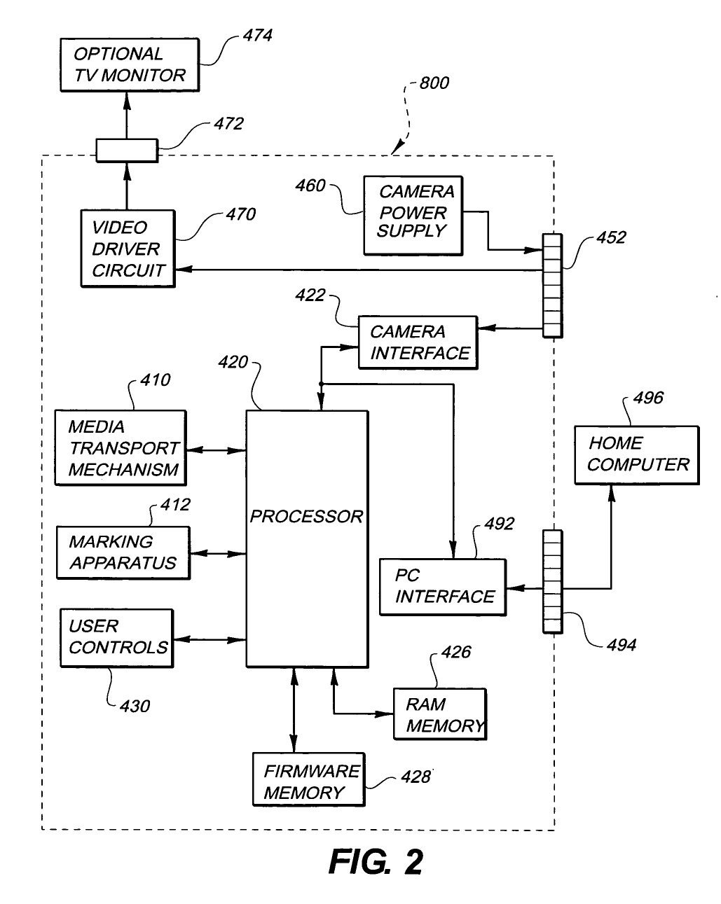

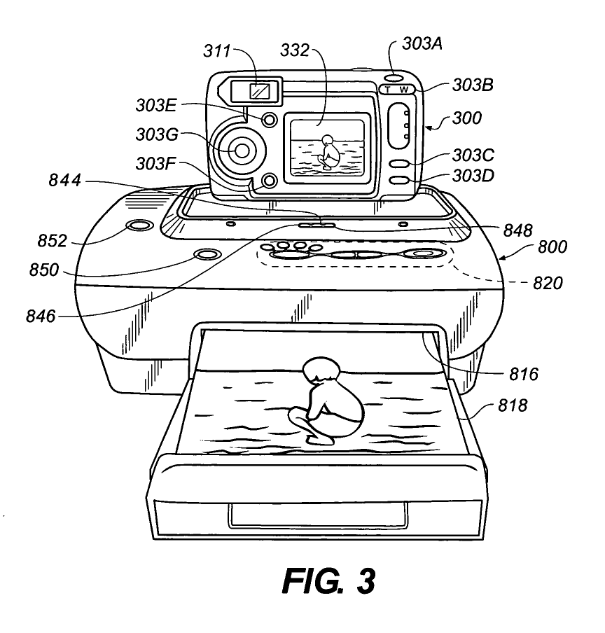

Referring now to the drawings, wherein like reference numerals represent identical or corresponding parts throughout the several views, a digital camera 300 is depicted in FIG. 1 and FIG. 3. Digital camera 300 captures and stores images using a digital memory, such as a memory card 330 as shown in FIG. 1. The stored digital images can be displayed on a color LCD image display 332. A digital printer 800, shown in detail in FIG. 2 and FIG. 3, produces color hardcopy prints using a color marking apparatus 412, such as a thermal printing head, and a media transport mechanism 410.

Digital printer 800 includes a camera interface 422, such as a USB interface, which connects to a first electrical connector 452 in order to receive digital images stored in the digital camera 300. In a preferred embodiment, the digital camera 300 also controls the images displayed on the color LCD image display 332 when the digital camera 300 is connected to the first electrical interface 452, as described in commonly assigned U.S. patent application Ser. No. 09/571,928 filed May 16, 2000, A PRINTING SYSTEM AND METHOD HAVING A DIGITAL PRINTER THAT USES A DIGITAL CAMERA IMAGE DISPLAY to Parulski et al., the disclosure of which is incorporated herein by reference.

Digital printer 800 also includes a PC interface 492, such as a USB interface, that connects to a second electrical interface 494 in order to receive digital images from a home computer 496 when the digital camera 300 is not connected to the first electrical interface 452. When the digital camera is connected to the first electrical interface 452, digital images can be transferred from the digital camera 300 to the home computer 496 using the electrical interfaces 452, 494. The transferred digital images can be stored in a non-volatile memory of the home computer 496, which can be, for example, a magnetic hard drive (not shown).

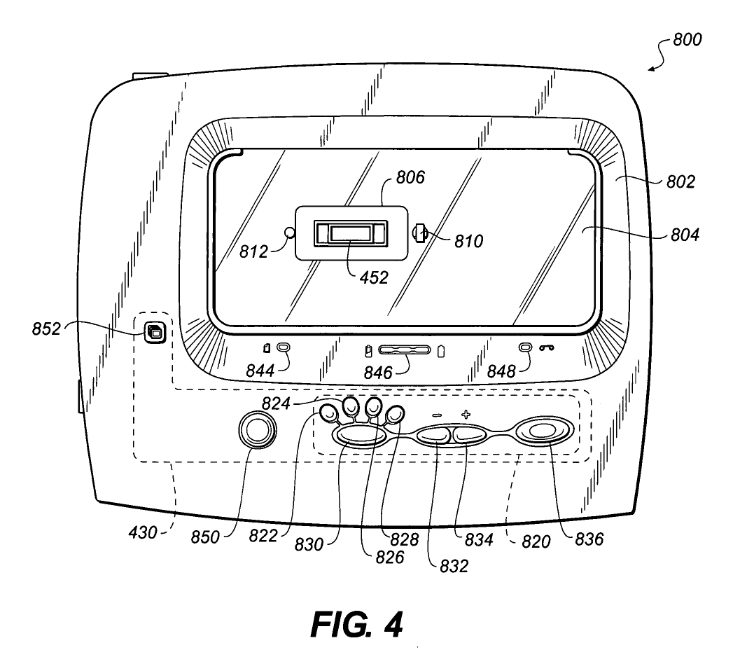

As illustrated in FIG. 2, digital printer 800 incorporates user controls 430 for initiating transfer of images from the memory card 330 in the digital camera to the home printer 496. The user controls 430 can also be used to select specific images to be printed from the plurality of digital images stored on memory card 330 within digital camera 300. The user controls 430 on the digital printer 800, shown in more detail in FIG. 4, are specifically arranged to provide easy control of the digital printer 800, since they do not need to be miniaturized in order to fit on a small portable digital camera, such as digital camera 300.

Referring now to FIG. 1 in detail, FIG. 1 is a block diagram showing digital camera 300 that captures and stores digital images on a digital storage medium, such as memory card 330. Digital camera 300 includes a zoom lens 312 having zoom and focus motor drives 310 and an adjustable aperture and shutter (not shown). The digital camera 300 includes user controls 303 which are shown in FIG. 3 as user controls 303A-303G. The user composes the image using optical viewfinder 311 and zoom lens control switch 303B shown in FIG. 3. Zoom lens 312 focuses light from a scene (not shown) on an image sensor 314, for example, a single-chip color CCD image sensor, using the well-known Bayer color filter pattern. Image sensor 314 is controlled by clock drivers 306. Zoom and focus motors 310 and clock drivers 306 are controlled by control signals supplied by a control processor and timing generator circuit 304. When the user depresses shutter button 303A (FIG. 3) to take a picture, control processor and timing generator 304 receives inputs from autofocus and autoexposure detectors 308 and controls a flash 302. The analog output signal from image sensor 314 is amplified and converted to digital data by analog signal processing (ASP) and analog-to-digital (A/D) converter circuit 316. The digital data is stored in a DRAM buffer memory 318 and subsequently processed by an image processor 320 controlled by the firmware stored in a firmware memory 328, which can be flash EPROM memory. The camera image processor can be a general purpose digital signal processor (DSP), or a custom processor designed specifically for use in a digital camera. In alternative embodiments, the functions of at least the image processor 320, firmware memory 328, RAM memory 326, DRAM buffer memory 318, and/or control processor and timing generator 304 can be combined on one or more integrated circuits.

Power for the digital camera 300 is provided by rechargeable batteries 360, via power supply circuits 362. In a preferred embodiment, the rechargeable batteries 360 are recharged from power provided by camera power supply 460 (FIG. 2) in the digital printer 800 via first electrical interface 452.

The processed digital image file is provided to a camera memory card interface 324, which stores the digital image file on memory card 330. Removable memory cards 330 which are described as an example in the present specification are known to those skilled in the art, and are one type of digital storage media. The memory card 330 can conform to the well-known Compact Flash, Smart Media, Memory Stick, MMC, SD, or XD memory card formats. The present invention is not limited to memory cards and it is noted that other types of digital storage media, such as magnetic hard drives, magnetic tape, or optical disks, can alternatively be used to store the digital images.

Processor 320 performs color interpolation followed by color and tone correction, in order to produce rendered sRGB image data. The rendered sRGB image data is then JPEG compressed and stored as a JPEG image file on memory card 330 using the well-known JPEG/Exif image file format. The JPEG/Exif image files can be utilized by many different image capable devices, such as computers and stand-alone printers. The JPEG/Exif image files are stored on the removable memory card 330 using a directory structure conforming to the well-known “Design Rule For Camera File System” (DCF) specification.

Processor 320 also creates a “thumbnail” size image, as described in commonly assigned U.S. Pat. No. 5,164,831 ELECTRONIC STILL CAMERA PROVIDING MULTI-FORMAT STORAGE OF FULL AND REDUCED RESOLUTION IMAGES to Kuchta et al., the disclosure of which is incorporated herein by reference. These thumbnail images are included along with the main (e.g. high resolution) image as part of the Exif image. The thumbnail image from the Exif image file can be retrieved from the memory card 330, stored in RAM memory 326, and supplied to a color LCD image display 332, which displays the captured image for the user to review. User controls 303 and the text, icons, and images displayed on the display 332 provide the camera graphical user interface (camera GUI). As shown in FIG. 3, the user controls 303 include a number of miniaturized buttons 303C-303F and a 4-way controller 303G. These controls must be small in order to fit on the back of camera 300, and arranged so that they do not get in the way during the picture taking operations. After a series of images have been taken by depressing shutter button 303A, review switch 303F may be pressed so that the captured images can be reviewed on color LCD image display 332.

When the camera is operated independently of the printer, the camera graphical user interface is controlled by the user interface portion of the firmware stored in firmware memory 328, which controls how the processor 320 responds to user controls 303 and creates the information displayed on display 332. Display 332 can be an active matrix color LCD display. Alternately, it can use other display technologies, such as organic light emitting diodes (OLEDs). In some embodiments, digital camera 300 also provides a video output signal (such as an NTSC or PAL video signal) produced by image processor 320 from the digital images stored on memory card 330, and supplied via to the digital printer 800 via the first electrical interface 452, for displaying the captured images on an optional TV monitor 474 (FIG. 2).

Digital camera 300 may include firmware stored in firmware memory 328 to control image processor 320 to enable the user to create a print order. The print order can be stored as a file, known as an image utilization file or print order file. The file indicates which images are to be printed. Utilization files are described in commonly-assigned U.S. Pat. No. 6,573,927 to Parulski, et. al., the disclosure of which is incorporated herein by reference. The print order file is created as a user selects images to be printed using user controls 303 while viewing the captured images on display 332, and is then stored on memory card 330 along with the image files. The print order file can be a text file (such as the well-known Digital Print Order Format (DPOF) file) that identifies the names of the captured images have been selected for printing, and how many copies of each individual image are to be printed.

After a series of images have been taken and stored on memory card 330, the camera 300 is inserted into a recess 804 in digital printer 800 shown in FIG. 4. The printer 800 includes a connector for the first electrical interface 452 which mates with a connector 352 in digital camera 300 (FIG. 1) in order to electrically interconnect printer interface 322 in digital camera 300 to camera interface 422 in digital printer 800.

Digital printer 800 produces digital prints 818 (shown in FIG. 4) from digital images stored on memory card 330 of digital camera 300 and transferred via first electrical interface 352. The first electrical interface 452 connects to camera interface circuit 422, which is connected to processor 420 and to PC interface 492. The PC interface 492 can be connected to home computer 496 through a second electrical interface 494.

In one preferred embodiment, the first electrical interface 452 and the second electrical interface 496 provide signals that conform to the well-known universal serial bus version 2.0 (USB 2) interface specification. In other embodiments, other interface specifications may be used, such as the well-known IEEE 1394 interface specification.

Digital printer 800 includes a media transport mechanism 410, such as a motor-driven roller, for moving hard copy media (e.g. paper) past a marking apparatus 412 (e.g., a color thermal printing head) under the control of a printer processor 420. Processor 420 controls the marking apparatus 412 to provide controlled amounts of various color inks or dyes in order to produce a pictorial image on the hardcopy media. Color marking apparatus 412 may alternately use color ink jet, color electrophotographic, encapsulated media, or color instant technologies to produce the digital prints. As shown in FIG. 3, digital printer 800 includes a paper exit slot 816 where the print can be ejected from digital printer 800.

A video output signal from the digital camera 300, supplied via connector 452, can be provided to an optional TV monitor 474, which connects using TV connector 472 to video driver circuit 470.

Digital printer 800 is controlled by firmware stored in printer firmware memory 428, which controls how processor 420 responds to the user controls 430. Since the image files created by digital camera 300 use the JPEG/Exif image format, they are JPEG compressed and must be decompressed prior to printing.

In some embodiments, the JPEG decompression and other processing needed to provide print data to the marking apparatus 412 is provided by processor 420. In an alternative embodiment, the decompression and other processing is provided by image processor 320 in camera 300, in order to reduce the required performance and cost of processor 420 in digital printer 800, as described in commonly assigned co-pending U.S. patent application Ser. No. 08/833,106 filed Jun. 14, 2000, PRINTER PARAMETER COMPENSATION BY A HOST CAMERA to Small, the disclosure of which is incorporated herein by reference. In such an alternative embodiment, image processor 320 also provides interpolation, sharpening, and color correction to prepare the image data properly to be used by the marking apparatus 412. This print image data is then transferred from the digital camera 300 to the digital printer 800 via first electrical connector 452.

The user can control digital printer 800 using the printer user controls 430. User controls 430 and the text, icons, and images displayed on the color LCD image display 332 of digital camera 300 or on the optional TV monitor 474 (FIG. 2) provide the printer graphical user interface (printer GUI). The printer GUI is controlled by the user interface portion of the firmware stored in printer firmware memory 428, which controls how processor 420 responds to user controls 430 and the color LCD image display control portion of the firmware stored in camera firmware memory 328, which controls how image processor 320 creates the information displayed on color LCD image display 332.

To quickly allow the images stored on memory card 330 to be displayed on color LCD image display 332, image processor 320 reads the “thumbnail” size images from the images provided on memory card 330. These thumbnail images are stored in RAM memory 326 and supplied to display 332, so that the user can select the images to be printed using user controls 430 on printer 800. The user controls 430 on the digital printer 800 are much larger that those on digital camera 300, since the digital printer 800 does not need to be a hand-held device. Furthermore, the user controls 430 can be arranged and labeled in order to be very easy to use. Instead of viewing the “thumbnail” size images on LCD image display 332, video size images can be viewed on the optional TV monitor 474. The video size images can be provided by using the image processor 320 to decimate the full resolution digital images stored on the memory card 330.

FIG. 4 depicts a top view of the digital printer 800. The printer 800 includes a raised top region 802 having recess 804 for receiving the digital camera 300. The recess 804 includes a connecting interface region 806 which includes a connector for the first electrical interface 452, which mates with electrical connector 352 in digital camera 300 (FIG. 1) in order to electrically connect the printer interface 322 in digital camera 300 to the camera interface 422 in digital printer 800. The recess 804 further includes pins for mechanically securing the digital camera 300, including a raised post 810 which slides inside the tripod mount hole (not shown) on the bottom of the digital camera 300, and a locating pin 812 which slides inside a locating hole (not shown) on the bottom of the digital camera 300.

The digital printer 800 includes user controls 430. The user controls 430 include a transfer button 850 and a slide show button 852. The transfer button 850 is used to initiate transfer of digital images from the memory card 330 of the digital camera 300 to the home computer 496 (see FIG. 2). The slide show button 852 is used to initiate a slide show display of all of the images stored on the memory card 330, either on the LCD 332 of the digital camera 332, or on an optional television monitor 474 (see FIG. 2), such as an NTSC or PAL video monitor. During the slide show display, the user can press print button 836 to create or update a print order, in order to obtain a print of the currently displayed image, as described in commonly-assigned U.S. patent application Ser. No. 10/375,669 filed Feb. 27, 2003, SYSTEM AND METHOD FOR VIEWING AND SELECTING IMAGES FOR PRINTING to Romano et al., the disclosure of which is incorporated herein by reference.

The user controls 430 also include a printing mode selection user interface 820, which includes a plurality of status icons 822-828, which comprise a printing mode display. Icon 822 indicates the “print order” printing mode, icon 824 indicates the “print current image” printing mode, icon 826 indicates the “print all” printing mode, and icon 828 indicates the “index print” printing mode. When the digital camera 300 is docked to the digital printer 800, the memory card 330 of the digital camera 330 is checked to determine if there is a print order, such as a DPOF file. If there is a print order, the printing mode is automatically set to the “print order” mode and icon 822 is displayed.

If there is no print order, the printing mode is automatically set to the “print current image” mode, and icon 824 is displayed. A “printing mode” button 830 is used to change modes. Each time the user presses the button 830, the printing mode cycles to the next mode. In other words, if the current mode is the “print order” mode, the mode changes to the “print current image” mode when button 830 is pressed a first time, then to the “print all” mode when button 830 is pressed a second time, then to the “index print” mode when button 830 is pressed a third time, and finally back to “print order” mode when button 830 is pressed a fourth time.

The user controls 430 also include “±” buttons 832 and 834. These buttons allow the current image, displayed on color image display 332 of digital camera 300, to be changed. For example, the user can push button 830 until the printing mode is set to “print current image” mode, and then press the “+” button 832 one or more times to display the next images in place of the current image, or press the “−” button one or more times to display a previous image as the current image. Then, the user presses the print button 836 to make a print of the currently displayed image.

The digital printer 800 includes a paper error LED 844 which blinks when the digital printer 800 has a paper error, such as a paper jam or an empty paper supply. The digital printer 800 also includes a donor error LED 848 which blinks when the digital printer 800 has a donor error, such as a donor ribbon jam or when the donor ribbon has been fully used. The digital printer 800 includes camera battery power LED indicators 846 which indicate the battery level of the rechargeable batteries 360 (see FIG. 1) of the digital camera 300.

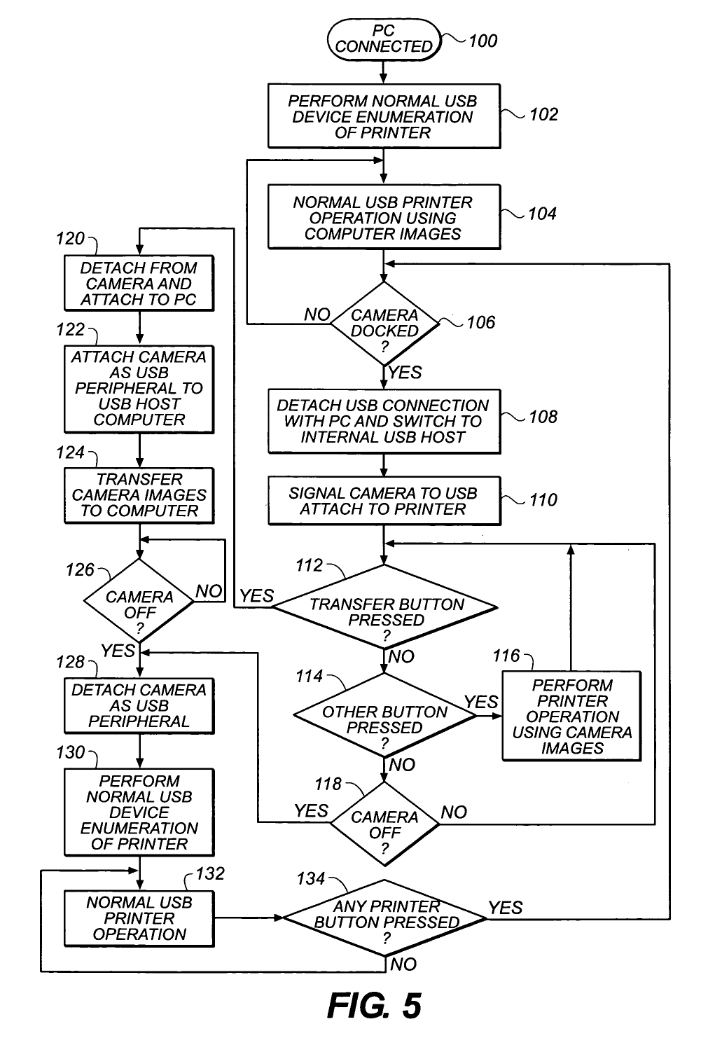

FIG. 5 depicts a flow diagram of a method for printing and transferring images using the digital printer 800. In block 100, the digital printer 800 is connected to the home computer 496. In a preferred embodiment, a USB cable is connected between the second electrical interface 494 and a USB host interface on the home computer 496.

In block 102, the normal USB device enumeration is performed in order to enumerate digital printer 800 as a USB printer device. The processor 420 in the digital printer 800, communicating via the PC interface 492 and the second electrical interface 494, identifies itself to the home computer 496 as a USB printer, and provides a Vendor Identifier and Product Identifier (VIDPID) as well as other data required by the USB standard. The home computer 496 uses the VIDPID to identify a device model for the digital printer 800 and to then locate an appropriate device driver that the home computer 496 can use in order to properly operate the digital printer 800.

In block 104, the digital printer 800 responds as a USB peripheral printer to USB printing commands issued by the home computer 496. This enables a user of the home computer 496 to select images for viewing and to print the images on the digital printer 800. For example, images stored on a hard drive of the home computer 496 can be selected, arranged, and printed using the methods described in commonly-assigned U.S. Pat. No. 6,453,078 to Bubie et al., the disclosure of which is incorporated herein by reference.

In block 106, the processor 420 determines if the user has connected the digital camera 300 to the first electrical interface 452 by docking the digital camera 300 with the digital printer 800. If not (no to block 106), block 104 is repeated.

If the user has connected the digital camera 300 to the digital printer 800 (yes to block 106), in block 108 the processor 420 causes the PC interface 492 to detach the USB connection with the home computer 496. This prevents the home computer 496 from controlling the digital printer 800, thus preventing the home computer 496 from supplying digital images to be printed over the second electrical interface 494. The processor 420 now begins to serve as a USB host device.

In block 110, the processor 420 provides USB commands to the digital camera 300 over the first electrical interface 452, in order to attach the digital camera 300 as a USB peripheral to the digital printer 800, which now serves as a USB host.

In block 112, the processor 420 determines if the user has pressed the transfer button 850 on the digital printer 800.

If the user has not pressed the transfer button 850 (no to block 112), in block 114 the processor 420 determines if the user has pressed any of the other user controls 430, such as the print button 836 or the printing mode button 830.

If the user has pressed one of the print buttons 830 other than the transfer button 850 (yes to block 114), in block 116 the digital printer 800 performs the user selected printer operation using the images from the digital camera 300, as was described earlier in reference to FIG. 4. These printer operations can include those described in commonly-assigned U.S. patent application Ser. No. 10/360,150 filed Feb. 6, 2003 A PRINTING SYSTEM AND METHOD HAVING A DOCKING DIGITAL PRINTER THAT USES A DIGITAL CAMERA IMAGE DISPLAY to Oliver et al., the disclosure of which is incorporated herein by reference. For example, if the user of the digital camera 300 created a print utilization file, as described earlier in reference to FIG. 1, the “print order” mode is automatically initiated and the print order icon 822 is indicated. When the user then presses the print button 836, the images stored in the memory card 330 of the digital camera 300 are printed as specified in the print order file. This is accomplished by transferring the print order file from the digital camera 300 to the digital printer 800, and then transferring and printing those digital images stored on the memory card 330 which are referenced for printing in the print utilization file. After performing the printing operation in block 116, block 112 is repeated.

If the user has not pressed any of the print buttons 830 in block 112 (no to block 112) and block 114 (no to block 114), in block 118 the processor 420 determines if the digital camera 300 has been powered off, for example as a result of a “time-out” condition sensed by the image processor 320 in the digital camera. This “time-out” condition can occur, for example, if the digital printer 800 has completed the printing operations in block 116 and if the user has not afterwards pressed any of the print buttons 830 for a predetermined period of time, such as 5 minutes. In such a case, the image processor 320 in the digital camera 300 would put the digital camera 300 into a low power mode. If the camera is in such an “off” mode, block 128 is performed. If, however, the camera is “on” (no to block 118), block 112 is repeated.

In block 112, if the user pressed the transfer button (yes to 112), in block 120 the processor 420 causes the camera interface 422 to detach the USB host connection with the digital camera 300, so that the digital printer 800 no longer acts as a USB host to the digital camera 300. Then, the processor 420 in the digital printer 800 connects the camera interface 422 directly to the PC interface 492, to enable a direct USB connection between the digital camera 300 and the home computer 496.

In block 122, the image processor 320 in the digital camera 300 communicates with the home computer 496, by way of the first electrical interface 452 and the second electrical interface 494, in order to enumerate the digital camera as a USB still camera peripheral device to home computer 496, which serves as a USB host. The image processor 320 in the digital camera 300 identifies itself to the home computer 496 as a USB still image class camera, and provides a Vendor Identifier and Product Identifier (VIDPID) for the digital camera 300. The home computer 496 uses the VIDPID to identify a device model for the digital camera 300 and to then locate an appropriate device driver that the home computer 496 can use in order transfer digital images from the digital camera 300.

In block 124, the digital images stored in the memory card 330 of the digital camera 300 are transferred to the home computer 496. The transfer of the digital images and image utilization files can use the methods described in commonly assigned U.S. patent application Ser. No. 10/081,255 filed Feb. 22, 2002, IMAGE APPLICATION SOFTWARE PROVIDING A LIST OF USER SELECTABLE TASKS to Herbert, the disclosure of which is incorporated herein by reference.

In block 126, when the digital camera 300 is powered off, as described earlier in reference to block 118, (yes to block 126), in block 128 the processor 420 in the digital printer 800 detaches the digital camera 300 as a USB peripheral to the home printer 496. This done by disconnecting the direct connection between camera interface 422 and the PC interface 492 that was made in block 120.

In block 130, the normal USB device enumeration is performed in order to enumerate digital printer 800 as a USB printer device as was described earlier in reference to block 102.

In block 132, the digital printer 800 responds as a USB peripheral printer to USB printing commands issued by the home computer 496, as was described earlier in reference to block 132.

In block 134, the processor 420 in the digital printer 800 determines if any of the user controls 430 have been pressed, such as the print button 836 or the print mode button 830. If none of the user controls 430 have been pressed (no to block 134), block 132 is repeated. If one of the user controls 430 has been pressed (yes to block 134), block 106 is repeated.

The invention has been described in detail with particular reference to certain preferred embodiments thereof, but it will be understood that variations and modifications can be effected within the spirit and scope of the invention.

1. A digital printer, comprising:
a marking apparatus adapted to print images;
a first electrical interface for connecting to a digital camera;
a second electrical interface for connecting to a computer; and
a processor for detecting when a digital camera is connected to the first electrical interface, for controlling the marking apparatus to print images provided from the digital camera when the digital camera is connected to the first electrical interface, and for controlling the marking apparatus to print images provided from the computer over the second electrical interface when the digital camera is not connected to the first electrical interface.

2. A printer according to claim 1, wherein the printer further includes a user activated control and wherein the processor, responsive to the user activated control, transfers images from the digital camera to the computer.

3. A printer according to claim 1, wherein the printer further includes a recess for receiving the digital camera.

4. A printer according to claim 1, wherein said first and second electrical interfaces are universal serial bus interfaces.

5. A printer according to claim 4, wherein the printer attaches to the computer as a USB peripheral when the digital camera is not connected to the first electrical interface.

6. A printer according to claim 5, wherein the printer detaches from the computer and switches to become a USB host to the digital camera when the digital camera is connected to the first electrical interface.

7. A printer according to claim 6, wherein the printer further includes a user control for initiating transfer of images from the digital camera to the computer.

8. A printer according to claim 7, wherein responsive to the user control, the printer detaches from the digital camera as the USB host and enables the digital camera to become attached as a USB peripheral to the computer.

9. A printer according to claim 1, wherein the marking apparatus includes an ink jet head.

10. A printer according to claim 1, wherein the marking apparatus uses color thermal dye sublimation.

11. A printer according to claim 1, wherein the first electrical interface provides power to recharge a battery in the digital camera.

12. A method of printing images, the method comprising the steps of:
providing a printer comprising a marking apparatus adapted to print images, a first electrical interface for connecting to a digital camera, and a second electrical interface for connecting to a computer;
detecting when a digital camera is connected to the first electrical interface;
controlling the marking apparatus to print images provided from the digital camera when the digital camera is connected to the first electrical interface; and
controlling the marking apparatus to print images provided from the computer over the second interface when the digital camera is not connected to the first electrical interface.

13. A method according to claim 12, further comprising the step of using a user activated control on the printer to initiate a transfer of the images from the digital camera to the computer.

14. A method according to claim 12, wherein the printer attaches to the computer as a USB peripheral when the digital camera is not connected to the first electrical interface.

15. A method according to claim 14, wherein the printer detaches from the computer and switches to become a USB host to the digital camera when the digital camera is connected to the first electrical interface.

16. A method according to claim 15, further comprising the step of using a user activated control on the printer to initiate a transfer of the images from the digital camera to the computer.

17. A method according to claim 16, wherein responsive to the user control, the printer detaches from the digital camera as the USB host and enables the digital camera to become the USB host to the digital camera.

18. A method according to claim 12, wherein the first electrical interface provides power to recharge a battery in the digital camera.
